(19) United States
(12) Patent Application Publication
(10) Pub. No.: US 2021/0277155 A1
(43) Pub. Date: Sep. 9, 2021

(54) Process for Preparing Polypropylene

(71) Applicants: Total Research & Technology Feluy, Seneffe (BE); Centre National de la Recherche Scientifque (CNRS), Paris (FR)

(72) Inventors: Alexandre Welle, Court-St-Etienne (BE); Aurélien Vantomme, Mignault (BE); Jean-François Carpentier, Acigné (FR); Gilles Schnee, Montpellier (FR); Olivier Miserque, Mont-Saint-Guibert (BE); Evgueni Kirillov, Cesson Sevigne (FR)

(21) Appl. No.: 16/330,645

(22) PCT Filed: Sep. 7, 2017
(86) PCT No.: PCT/EP2017/072397

§ 371 Date: Mar. 5, 2019

(30) Foreign Application Priority Data
Sep. 8, 2016 (EP) 16290167.2

(51) Int. Cl. C08F 10/06; C08F 2/02; C08F 4/659; C08F 4/6592

(52) U.S. Cl. CPC C08F 10/06; C08F 2/02; C08F 2410/03; C08F 4/65927; C08F 4/65912

(57) ABSTRACT

The present invention relates to a new process for preparing a polypropylene using new bis(metallocene) compounds in catalyst compositions. The bis(metallocene) compounds of the invention are homo- or hetero bis(metallocene) molecules in which same or different metallocene moieties are connected by a phenylene bridge. The phenylene bridge is either para-substituted, meta-substituted or ortho-substituted by the two metallocene moieties

### TECHNICAL FIELD OF THE INVENTION

The invention is in the field of polymers technology, and relates to a process for preparing polypropylene. In particular the invention relates to the preparation of multimodal or bimodal polypropylene.

### BACKGROUND OF THE INVENTION

A constant mechanical properties improvement is required in the field of the polymer industry. Such improvement can for example be obtained by tailor made bimodal resins synthesized by metallocene catalysts combined with cascade reactor. The polypropylene resins having bimodal characteristics include resins that comprise two components having different properties, such as for instance two components of different molecular weight, two components of different crystallinity, or melting temperature and/or two components having different reaction rate with respect to co-monomer.

Bimodal propylene polymers can be prepared by a physical blending of different monomodal polypropylene or by sequential polymerization in two separate reactors that are serially interconnected. In such sequential process in cascade reactors, one of the two components of the bimodal blend is produced under a set of conditions in a first reactor and transferred to a second reactor, where under another set of conditions different from those in the first reactor, the second component is produced. Because of the different set of conditions, the second component has properties (such as molecular weight, crystallinity, melting temperature, etc.) different from the properties of the first component.

However, the requirement of multiple reactors leads to increase costs for both construction and operation.

To overcome this problem, it is possible to use multiple catalysts in a single reactor, each catalyst producing a polypropylene component. An example of such a process is given by the document WO2007/147864 describing a process for the production of propylene polymers in one or more reactor in presence of two Ziegler-Natta catalysts having different internal electron donors.

Typically, in such a case, multiple separate catalyst injections are performed. For example, the different catalysts are injected separately into the polymerization reactor. Although this process shows high flexibility, several drawbacks must be highlighted: multiple catalysts injections lead to increased costs and polymer homogeneity is difficult to achieve.

Another strategy is the heterogenisation of multiple catalysts on same support which seems to solve those drawbacks, for example for metallocene catalysts. However, this technology suffers from the difficulty to control properly the behavior of metallocene during the heterogenisation process typically leading a dominating structure while the other seems inactive.

Thus, it remains a need in the art to provide an improved process for preparing bimodal or multimodal propylene polymers in a single reactor.

### SUMMARY OF THE INVENTION

The present invention provides such an improved process for preparing propylene polymers having bimodal or multimodal characteristics in one or more reactor, preferably in one reactor. In accordance with an embodiment of the present invention, a bimodal propylene polymer is prepared in a single reactor in a process involving the use of a catalyst composition including a bis(metallocene) compound.

The invention relates to a process for the production of propylene polymers, said process comprising the step of polymerizing propylene monomer and optionally one or more olefin co-monomer in one or more polymerization reactors in presence of a catalyst composition wherein the catalyst composition comprises a bis(metallocene) compound (A) having one of the following formulas:

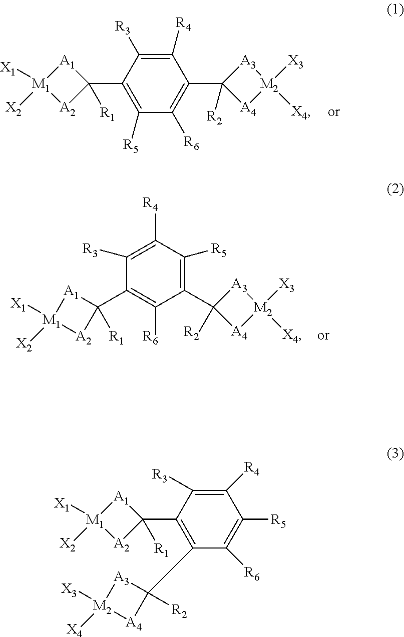

### Wherein,

A1 and A3 are the same or different substituted or unsubstituted cyclopentadienyl rings, or substituted or unsubstituted fluorenyl rings, or substituted or unsubstituted indenyl rings, wherein if substituted, the substitutions may be independent and/or linked to form multicyclic structures;
A2 and A4 are the same or different and selected from substituted or unsubstituted cyclopentadienyl rings or substituted or unsubstituted fluorenyl rings, or substituted or unsubstituted indenyl rings;
X1, X2, X3 and X4 are independently hydrogen, halogen, hydride group, hydrocarbyl group, substituted hydrocarbyl group, alkoxyde group, substituted alkoxyde group, aryloxide group, substituted aryloxide group, halocarbyl group, substituted halocarbyl group, silylcarbyl group, substituted silylcarbyl group, germylcarbyl group, substituted germylcarbyl group, or both X1 and X2 and/or both X3 and X4 are joined and bound to the metal atom to form a metallacycle ring containing from 3 to 20 carbon atoms;
M1 is Zirconium;
M2 is selected from Zirconium, Hafnium and Titanium;
R1 and R2 are independently hydrogen or a substituted or unsubstituted aliphatic, aromatic, or cyclic group;
R3, R4, R5 and R6 are independently hydrogen or a substituted or unsubstituted aliphatic, aromatic, or cyclic group.

With preference one or more of the following embodiments can be used to define the inventive process:
In the bis(metallocene) compound (A), both M1 and M2 are zirconium or M1 and M2 are different and preferably M2 is Hafnium.
In the bis(metallocene) compound (A), A1 and A3 are the same and A2 and A4 are the same so that the bis(metallocene) compound (A) shows a symmetry.
In the bis(metallocene) compound (A), A1 and A3 are the same or different substituted or unsubstituted cyclopentadienyl rings, or substituted or unsubstituted fluorenyl rings, or substituted or unsubstituted indenyl rings, wherein if substituted, the substitutions may be independent and/or linked to form multicyclic structures.
In the bis(metallocene) compound (A), A1 and A3 are the same or different substituted or unsubstituted cyclopentadienyl rings, or substituted or unsubstituted fluorenyl rings, wherein if substituted, the substitutions may be independent and/or linked to form multicyclic structures.
In the bis(metallocene) compound (A), A1 and A3 are the same or different substituted or unsubstituted cyclopentadienyl rings wherein if substituted, the substitutions may be independent and/or linked to form multicyclic structures.
In the bis(metallocene) compound (A), A1 and A3 are the same or different substituted or unsubstituted fluorenyl rings wherein if substituted, the substitutions may be independent and/or linked to form multicyclic structures.
In the bis(metallocene) compound (A), A1 and A3 are the same or different substituted or unsubstituted indenyl rings wherein if substituted, the substitutions may be independent and/or linked to form multicyclic structures.
In the bis(metallocene) compound (A), A2 and A4 are the same or different and selected from substituted or unsubstituted cyclopentadienyl rings, or substituted or unsubstituted fluorenyl rings. In the bis(metallocene) compound (A), R1 and R2 are independently hydrogen or a methyl group.
In the bis(metallocene) compound (A), R3, R4, R5 and R6 are hydrogen.
In the bis(metallocene) compound (A), at least one of A1, A2, A3 or A4 is a fluorenyl ring.
The bis(metallocene) compound (A) is:

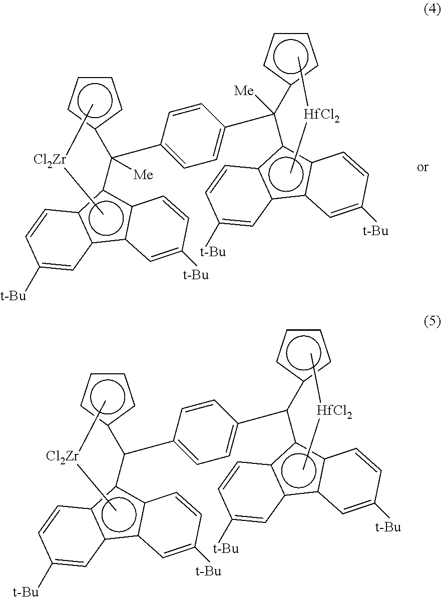

The catalyst composition further comprises a co-catalyst (B).
The co-catalyst (B) is an alumoxane selected from methylalumoxane, modified methyl alumoxane, ethylalumoxane, isobutylalumoxane, or any combination thereof, preferably the co-catalyst (B) is methylalumoxane (MAO).
The co-catalyst is an ionic activator selected from dimethylanilinium tetrakis(perfluorophenyl)borate, triphenylcarbonium tetrakis (perfluorophenyl) borate, dimethylanilinium tetrakis(perfluorophenyl)aluminate, or any combination thereof, preferably the ionic activator is dimethylanilinium tetrakis(perfluorophenyl)borate.
The co-catalyst (B) is an ionic activator used in combination with a co-activator being a trialkylaluminium selected from Tri-Ethyl Aluminum (TEAL), Tri-Iso-Butyl Aluminum (TIBAL), Tri-Methyl Aluminum (TMA), and Methyl-Methyl-Ethyl Aluminum (MMEAL), preferably the co-activator is Tri-Iso-Butyl Aluminum (TIBAL).
The bis(metallocene) compound (A) is or comprises a mixture of a homo bis(metallocene) wherein both M1 and M2 are Zirconium and of a hetero bis(metallocene) wherein M1 and M2 are different and further wherein preferably M2 is Hafnium.
The process is performed in a single reactor, preferably in a single loop reactor.
The process is performed in double loop reactor.
The process is carried out in bulk conditions.
The propylene polymer obtained by the process, has a melting temperature Tₘ of at least 110° C. preferably of at least 145° C. Melting temperatures may be determined according to ISO 3146.
The propylene polymer obtained by the process, has a molecular weight distribution (MWD), defined as Mw/Mn, i.e. the ratio of weight average molecular weight (Mw) over number average molecular weight (Mn) of at least 2.5, most preferably of at least 2.7.
The process involves a bis(metallocene) compound (A) wherein both M1 and M2 are zirconium or M1 and M2 are different and preferably M2 is Hafnium, or a bis(metallocene) compound (A) being or comprising a mixture of a homo bis(metallocene) wherein both M1 and M2 are Zirconium and of a hetero bis(metallocene) wherein M1 and M2 are different and further wherein preferably M2 is Hafnium; and the propylene polymer obtained has a molecular weight distribution (MWD), defined as Mw/Mn, i.e. the ratio of weight average molecular weight (Mw) over number average molecular weight (Mn) of at least 3, preferably at least 3.5, more preferably at least 4.
The propylene polymer obtained by the process, has a content of rrrr pentads ranging from 65 to 90 mol % as determined by ¹³C-NMR analysis.
The propylene polymer obtained by the process, is a copolymer of propylene and ethylene.
The propylene polymer obtained by the process is a syndiotactic polypropylene.
The polypropylene polymer is a bimodal propylene polymer, preferably the propylene polymer has a bimodal molecular weight distribution.
The propylene polymer is a multimodal propylene polymer.
The propylene polymer is a propylene homopolymer.
The propylene polymer is a propylene copolymer selected from a random propylene copolymer and a heterophasic propylene copolymer.
The polymer propylene is a heterophasic propylene copolymer, and is produced sequentially in one or more loop reactors and one or more gas-phase reactors.

It is noted that other bis(metallocene) compositions than the ones used in accordance with the invention, are already disclosed in prior art such as in WO2010/151315. However, this document does not disclose obtaining bimodal polyolefins in a single reactor.

The invention also encompasses the propylene polymer as defined above and polypropylene compositions comprising the propylene polymer as defined above.

The present invention further encompasses articles comprising the polypropylene resin produced according to the present process. Preferred articles are thermoformed articles or molded articles selected from injection molded articles, compression molded articles, rotomoulded articles, injection blow molded articles, and injection stretch blow molded articles, preferably injection molded articles. In an embodiment, the articles are selected from the group consisting of automobile parts, food or non-food packaging, retort packaging, housewares, caps, closures, media packaging, medical devices and pharmacopoeia packages.

### DESCRIPTION OF THE FIGURES

FIGS. 1a and 1b are the mass spectrum of the mixture of homo- and hetero bis(metallocene) compound (5a and 5b) as obtained according to scheme 8, evidencing the presence of hetero zirconium-hafnium complexes.

### DETAILED DESCRIPTION OF THE INVENTION

For the purpose of the invention the following definitions are given:

As used herein, a “polymer” is a polymeric compound prepared by polymerising monomers, whether of the same or a different type. The generic term polymer thus embraces the term homopolymer, usually employed to refer to polymers prepared from only one type of monomer, and the terms copolymer and interpolymer as defined below.

As used herein, a “copolymer”, “interpolymer” and like terms mean a polymer prepared by the polymerisation of at least two different types of monomers. These generic terms include polymers prepared from two or more different types of monomers, i.e. terpolymers, tetrapolymers, etc.

For the purpose of the invention, the terms “polypropylene” (PP) and “propylene polymer” may be used synonymously. The term “metallocene polypropylene” is used to denote a polypropylene produced with a metallocene-based polymerization catalyst. The produced metallocene polypropylene may be labeled as “mPP”. A metallocene polypropylene can be derived from polypropylene and a comonomer such as one or more selected from the group consisting of ethylene and C₄—C-₁₀ alpha-olefins, such as 1-butene, 1-pentene, 1-hexene, 1-octene.

The term “polypropylene” or “polypropylene resin” as used herein refers to the polypropylene fluff or powder that is extruded, and/or melted and/or pelletized, for instance with mixing and/or extruder equipment. The term “fluff” or “powder” as used herein refers to the polypropylene material with the hard catalyst particle at the core of each grain and is defined as the polymer material after it exits the polymerization reactor (or final polymerization reactor in the case of multiple reactors connected in series).

“Bimodal polypropylene” as used herein refers to a bimodal polypropylene resin comprising two components having different properties, such as for instance two components of different molecular weight, two components of different densities, and/or two components having different productivities or reaction rate with respect to co-monomer. In an example, one of said fractions has higher molecular weight than said other fraction.

“Multimodal polypropylene” as used herein refers to a multimodal polypropylene resin comprising two or more components having different properties, such as for instance two or more components of different molecular weight, two or more component components of different densities, and/or two or more components having different productivities or reaction rate with respect to co-monomer. In accordance with an embodiment of the invention, multimodal polypropylene comprising more than two components having different properties may be obtained in two reactors connected in series and operated under different set of conditions.

The term “co-catalyst” is used generally herein to refer to organoaluminum compounds that can constitute one component of a catalyst composition. Additionally, “co-catalyst” refers to other component of a catalyst composition including, but not limited to, aluminoxanes, organoboron or organoborate compounds and ionizing ionic compound (i.e. ionic activator). The term “co-catalyst” is used regardless of the actual function of the compound or any mechanical mechanism by which the compound may operate. In one aspect of this invention the term “co-catalyst” is used to distinguish that component of the catalyst composition from the bis(metallocene) compound.

The term “bis(metallocene)”, as used herein, describes a compound comprising two metallocene moieties linked by a phenylene group.

Unless otherwise specified the following abbreviations may be used Cp for cyclopentadienyl, Ind for indenyl, and Flu for fluorenyl.

For any particular compound disclosed herein, any general or presented structure presented also encompasses all conformational isomers, regioisomers, and stereoisomers that may arise from a particular set of substituents. The general or specific structure also encompasses all enantiomers, diastereomers, and other optical isomers whether in enantiomeric or racemic forms, as well as mixtures of stereoisomers, as would be recognized by a person skilled in the art.

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

The recitation of numerical ranges by endpoints includes all numbers and fractions subsumed within the respective ranges, as well as the recited endpoints.

The particular features, structures, characteristics or embodiments may be combined in any suitable manner, as would be apparent to a person skilled in the art from this disclosure, in one or more embodiments.

The present invention is directed to a process preparing a propylene polymer in one or more reactors using new catalyst compositions comprising new bis(metallocene) compounds. In particular, the invention is directed to a process for preparing bimodal or multimodal polypropylene resin in one or more reactors, preferably in a single reactor.

The bis(metallocene) of the invention are homo- or heterodinuclear molecules in which same or different metallocene moieties are connected by a phenylene bridge. The phenylene bridge is either para-substituted, meta-substitutedor or ortho-substituted by the two metallocene moieties.

The present invention relates to a process for preparing a propylene polymer in one or more reactors, comprising polymerizing propylene monomer and optionally one or more olefin co-monomer in the presence of a catalyst composition wherein the catalyst composition comprises a bis(metallocene) compound (A) having one of the following formulas:

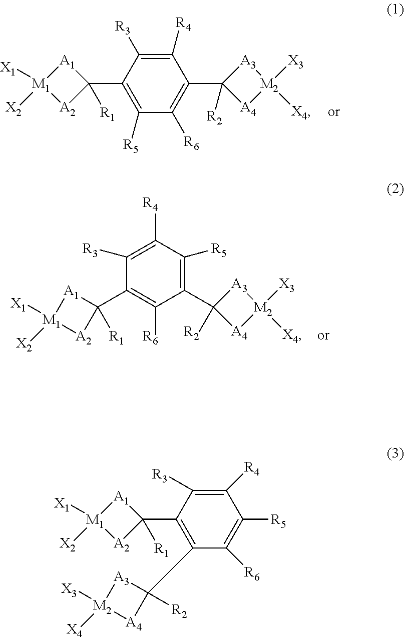

wherein
A1 and A3 are the same or different substituted or unsubstituted cyclopentadienyl rings, or substituted or unsubstituted fluorenyl rings, or substituted or unsubstituted indenyl rings, wherein if substituted, the substitutions may be independent and/or linked to form multicyclic structures;
A2 and A4 are the same or different and selected from substituted or unsubstituted cyclopentadienyl rings or substituted or unsubstituted fluorenyl rings, or substituted or unsubstituted indenyl rings;
X1, X2, X3 and X4 are independently hydrogen, halogen, hydride group, hydrocarbyl group, substituted hydrocarbyl group, alkoxyde group, substituted alkoxyde group, aryloxide group, substituted aryloxide group, halocarbyl group, substituted halocarbyl group, silylcarbyl group, substituted silylcarbyl group, germylcarbyl group, substituted germylcarbyl group, or both X1 and X2 and/or both
X3 and X4 are joined and bound to the metal atom to form a metallacycle ring containing from 3 to 20 carbon atoms;
M1 is Zirconium;
M2 is selected from Zirconium, Hafnium and Titanium;
R1 and R2 are independently hydrogen or a substituted or unsubstituted aliphatic, aromatic, or cyclic group;
R3, R4, R5 and R6 are independently hydrogen or a substituted or unsubstituted aliphatic, aromatic, or cyclic group.

In these formulas halogen includes fluorine (F), chlorine (Cl), bromine (Br), and iodine (I) atoms.

As used herein, an aliphatic group includes linear or branched alkyl and alkenyl groups. Generally, the aliphatic group contains from 1 to 20 carbon atoms. Unless otherwise specified, alkyl and alkenyl groups described herein are intended to include all structural isomers, linear or branched, of a given moiety; for example, all enantiomers and all diastereomers are included within this definition. As an example, unless otherwise specified, the term propyl is meant to include n-propyl and iso-propyl, while the term butyl is meant to include n-butyl, iso-butyl, t-butyl, sec-butyl, and so forth.

Suitable examples of alkyl groups which can be employed in the present invention include, but are not limited to, methyl, ethyl, propyl, butyl, pentyl, hexyl, heptyl, octyl, nonyl, or decyl, and the like. Examples of alkenyl groups within the scope of the present invention include, but are not limited to, ethenyl, propenyl, butenyl, pentenyl, hexenyl, heptenyl, octenyl, nonenyl, decenyl, and the like.

Aromatic groups and combinations with aliphatic groups include aryl and arylalkyl groups, and these include, but are not limited to, phenyl, alkyl-substituted phenyl, naphthyl, alkyl-substituted naphthyl, phenyl-substituted alkyl, naphthyl-substituted alkyl, and the like. Generally, such groups and combinations of groups contain less than about 20 carbon atoms. Hence, non-limiting examples of such moieties that can be used in the present invention include phenyl, tolyl, benzyl, dimethylphenyl, trimethylphenyl, phenylethyl, phenylpropyl, phenylbutyl, propyl-2-phenylethyl, and the like.

Cyclic groups include cycloalkyl and cycloalkenyl moieties and such moieties can include, but are not limited to, cyclopentyl, cyclopentenyl, cyclohexyl, cyclohexenyl, and the like. One example of a combination including a cyclic group is a cyclohexylphenyl group.

Unless otherwise specified, any substituted aromatic or cyclic moiety used herein is meant to include all regioisomers; for example, the term tolyl is meant to include any possible substituent position, i.e. ortho, meta, or para.

Hydrocarbyl is used herein to specify a hydrocarbon radical group that includes, but is not limited to, aryl, alkyl, cycloalkyl, alkenyl, cycloalkenyl, cycloalkadienyl, alkynyl, aralkyl, aralkenyl, aralkynyl, and the like, and includes all substituted, unsubstituted, branched, linear, and/or heteroatom substituted derivatives thereof. Unless otherwise specified, the hydrocarbyl groups of this invention typically comprise up to about 20 carbon atoms. In another aspect, hydrocarbyl groups can have up to 12 carbon atoms, for instance, up to 8 carbon atoms, or up to 6 carbon atoms.

Alkoxide and aryloxide groups both can comprise up to about 20 carbon atoms. Illustrative and non-limiting examples of alkoxide and aryloxide groups (i.e., hydrocarbyloxide groups) include methoxy, ethoxy, propoxy, butoxy, phenoxy, substituted phenoxy, and the like.

Silylcarbyl groups are groups in which the silyl functionality is bonded directly to the indicated atom or atoms. Examples include SiH₃, SiH₂R*, SiHR*₂, SiR*₃, SiH₂(OR*), SiH(OR*)₂, Si(OR*)₃, SiH₂(NR*₂), SiH(NR*₂)₂, Si(NR*₂)₃, and the like where R* is independently a hydrocarbyl or halocarbyl radical and two or more R* may join together to form a substituted or unsubstituted saturated, partially unsaturated or aromatic cyclic or polycyclic ring structure.

Germylcarbyl groups are groups in which the germyl functionality is bonded directly to the indicated atom or atoms. Examples include GeH₃, GeH₂R*, GeHR*₂, GeR*₃, GeH₂(OR*), GeH(OR*)₂, Ge(OR*)₃, GeH₂(NR*₂), GeH(NR*₂)₂, Ge(NR*₂)₃, and the like where R* is independently a hydrocarbyl or halocarbyl radical and two or more R* may join together to form a substituted or unsubstituted saturated, partially unsaturated or aromatic cyclic or polycyclic ring structure.

In a preferred embodiment, A1 and A3 are the same and A2 and A4 are the same so that the bis(metallocene) compound (A) shows a symmetry.

In another preferred embodiment R1 and R2 are independently hydrogen or a methyl group, and/or R3, R4, R5 and R6 are hydrogen, and/or, at least one of A1, A2, A3 or A4 is a fluorenyl ring.

The bis(metallocene) compound of the invention may be hetero bis(metallocene) compound because each metallocene moiety linked by the phenylene bridge is the different and/or contain a different metal center. Non-limiting examples of hetero bis(metallocene) compounds in accordance with the invention have the following formulas:

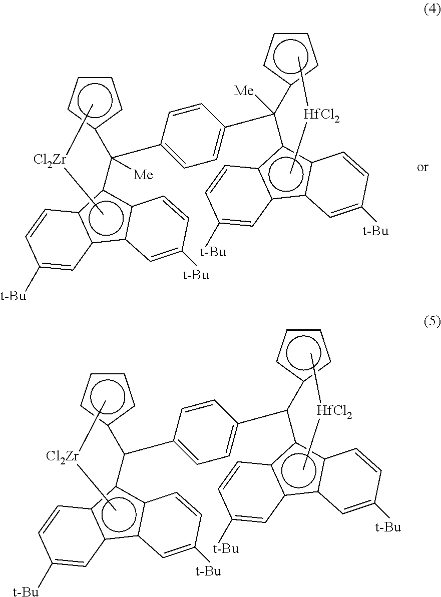

The bis(metallocene) compound of the invention may be homo bis(metallocene) compound because each metallocene moiety linked by the phenylene bridge is the same and contain the same metal center. Non-limiting examples of homo bis(metallocene) compounds in accordance with the invention have the following formulas:

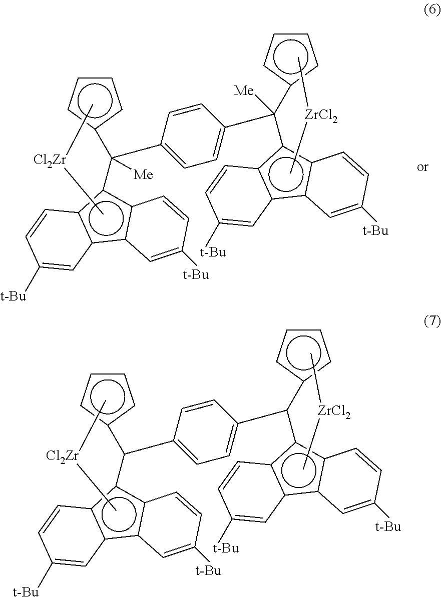

Methods of making bis(metallocene) compounds of the present invention are also provided. Bis(metallocene) compounds were obtained using a standard salt metathesis reaction between two equivalents of the metal precursors and ligand tetra anions.

The metal precursor is a mixture of zirconium tetrachloride (ZrCl₄) with one selected from zirconium tetrachloride (ZrCl₄), hafnium tetrachloride (HfCl₄), titanium tetrachloride (TiCl₄), zirconium tetrachloride complex 1:2 with tetrahydrofuran (ZrCl₄.2THF); hafnium tetrachloride complex 1:2 with tetrahydrofuran (HfCl₄.2THF) and titanium tetrachloride complex 1:2 with tetrahydrofuran (TiCl₄.2THF).

The proligand has one of the following formulas:

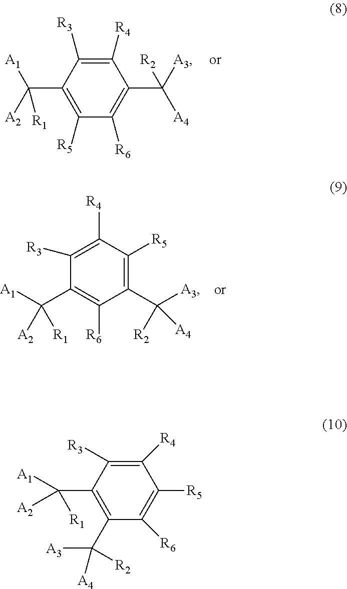

wherein
A1 and A3 are the same or different substituted or unsubstituted cyclopentadienyl rings, or substituted or unsubstituted fluorenyl rings, or substituted or unsubstituted indenyl rings, wherein if substituted, the substitutions may be independent and/or linked to form multicyclic structures;
A2 and A4 are the same or different and selected from substituted or unsubstituted cyclopentadienyl rings, or substituted or unsubstituted fluorenyl rings, or substituted or unsubstituted indenyl rings;
R1 and R2 are independently hydrogen or a substituted or unsubstituted aliphatic, aromatic, or cyclic group;
R3, R4, R5 and R6 are independently hydrogen or a substituted or unsubstituted aliphatic, aromatic, or cyclic group.
For example the proligand is a bis (Cp/flu) proligand of the following formula

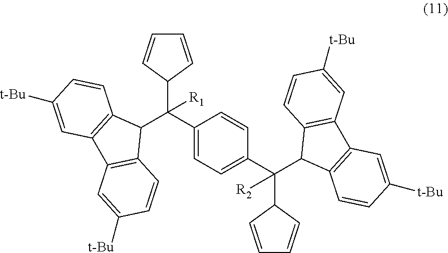

wherein R1 and R2 are independently hydrogen or a substituted or unsubstituted aliphatic, aromatic, or cyclic group

Synthesis process of such proligand is well known to the person skilled in the art and is described for example in U.S. Pat. Nos. 2,512,698 and 2,587,791, which are included herein by reference. With preference, in the invention, pyrolidine is used as catalyst of the reaction.

The catalyst composition according to the invention preferably comprises a bis(metallocene) compound (A) as defined above and a co-catalyst (B).

In a preferred embodiment the co-catalyst (B) is an alumoxane selected from methylalumoxane, modified methyl alumoxane, ethylalumoxane, isobutylalumoxane, or any combination thereof, preferably the co-catalyst (B) is methylalumoxane (MAO).

In another preferred embodiment, the co-catalyst (B) is an ionic activator selected from dimethylanilinium tetrakis(perfluorophenyl)borate, triphenylcarbonium tetrakis (perfluorophenyl) borate, dimethylanilinium tetrakis(perfluorophenyl)aluminate, or any combination thereof, preferably the ionic activator is dimethylanilinium tetrakis(perfluorophenyl)borate. In such a case the co-catalyst (B) is preferably used in combination with a co-activator being a trialkylaluminium selected from Tri-Ethyl Aluminum (TEAL), Tri-Iso-Butyl Aluminum (TIBAL), Tri-Methyl Aluminum (TMA), and Methyl-Methyl-Ethyl Aluminum (MMEAL), preferably the co-activator is Tri-Iso-Butyl Aluminum (TIBAL).

In a preferred embodiment, the bis(metallocene) compound (A) comprises a mixture of a homo bis(metallocene) wherein both M1 and M2 are zirconium and of a hetero bis(metallocene) wherein M1 and M2 are different and further wherein preferably M2 is hafnium. Preferably, in such a case, the proligand used to produce the dinuclear compound is the same in the homo bis(metallocene) and in the hetero bis(metallocene). The mixture of homo- and hetero bis(metallocene) compound is obtained by reaction of metal precursors and a I tetra anion ligand.

The metallocene may be supported according to any method known in the art. In the event it is supported, the support used in the present invention can be any organic or inorganic solid, particularly porous support such as talc, inorganic oxides, and resinous support material such as polyolefin. Preferably, the support material is an inorganic oxide in its finely divided form.

The polymerisation of propylene and one or more optional comonomers in the presence of a bis(metallocene) catalyst composition can be carried out according to known techniques in one or more polymerisation reactors. With preference, the polymerisation of propylene and one or more optional comonomers in presence of bis(metallocene) catalyst composition according to the invention is carried out in a single polymerisation reactor.

The polypropylenes of the present invention are preferably produced by polymerization in liquid propylene at temperatures in the range from 20° C. to 100° C. Preferably, temperatures are in the range from 60° C. to 80° C. The pressure can be atmospheric or higher, preferably between 25 and 50 bar. The molecular weight of the polymer chains, and in consequence the melt flow of the metallocene polypropylene, is regulated by the addition of hydrogen to the polymerization medium.

Preferably, the polypropylene obtained by the invention has a melting temperature Tₘ of at least 110° C., preferably of at least 145° C. Melting temperatures may be determined according to ISO 3146.

The polypropylene has a melt flow index (MFI) ranging from 0.1 to 1000 g/10 min, preferably 0.1 to 500 g/10 min. Preferably, the polypropylene has a melt flow index (MFI) of at most 200 g/10 min. The value of MFI of the polypropylene is obtained without degradation treatment.

Preferably, the polypropylene of the invention has a molecular weight distribution (MWD), defined as Mw/Mn, i.e. the ratio of weight average molecular weight (Mw) over number average molecular weight (Mn) of at least 2.5, most preferably of at least 2.7.

In an embodiment, the process involves:
a bis(metallocene) compound (A) wherein both M1 and M2 are zirconium or M1 and M2 are different and preferably M2 is Hafnium, or
a bis(metallocene) compound (A) being or comprising a mixture of a homo bis(metallocene) wherein both M1 and M2 are Zirconium and of a hetero bis(metallocene) wherein M1 and M2 are different and further wherein preferably M2 is Hafnium;
   and the propylene polymer obtained has a molecular weight distribution (MWD), defined as Mw/Mn, i.e. the ratio of weight average molecular weight (Mw) over number average molecular weight (Mn) of at least 3, preferably at least 3.5, more preferably at least 4.

Preferably, the polypropylene has a molecular weight distribution (MWD), defined as Mw/Mn, i.e. the ratio of weight average molecular weight (Mw) over number average molecular weight (Mn), of at most 10, preferably of at most 6.

Preferably, the polypropylene produced according to the invention is syndiotactic polypropylene. Preferably, said at least one single-site catalyst polypropylene is syndiotactic. Syndiotactic polypropylene is polypropylene wherein the methyl groups attached to the tertiary carbon atoms of the successive monomeric unit are arranged as racemic dyads. In other words, the methyl groups in isotactic polypropylene lie on the same side of the polymer backbone whereas in syndiotactic polypropylene the methyl groups lie on alternate sides of the polymer backbone. In the absence of any regular arrangement of the methyl groups with respect to the polymer backbone the polymer is atactic.

Syndiotactity may be measured by ¹³C-NMR analysis as described in the test methods and may be expressed as the percentage of syndio pentads (% rrrr). As used herein, the term “syndio pentads” refers to successive methyl groups located on alternate sides of the polymer chain. Preferably the content of rrrr pentads of the polypropylene produced according to the invention is ranging from 65 to 90 mol % as determined by ¹³C-NMR analysis.

The polypropylene is a homopolymer, a copolymer of propylene and at least one comonomer, or a mixture thereof.

In a preferred embodiment of the invention, the polypropylene is a homopolymer of propylene. A homopolymer according to this invention has less than 0.1 wt %, preferably less than 0.05 wt % and more preferably less than 0.005 wt %, of alpha-olefins other than propylene in the polymer. Most preferred, no other alpha-olefins are detectable.

In an embodiment, the propylene polymer is a propylene copolymer. The propylene copolymer can be a random copolymer, a heterophasic copolymer, or a mixture thereof.

Suitable comonomers can be selected from the group consisting of ethylene and aliphatic C₄-C₂₀ alpha-olefins. Example of suitable aliphatic C₄-C₂₀ alpha-olefins include 1-butene, 1-pentene, 4-methyl-1-pentene, 1-hexene, 1-octene, 1-decene, 1-dodecene, 1-tetradecene, 1-hexadecene, 1-octadecene and 1-eicosene. Preferably, the comonomer is ethylene.

The random propylene copolymer comprises at least 0.1 wt % of one or more comonomers, preferably at least 1 wt %. The random propylene copolymer comprises up to 10 wt % of one or more comonomers and most preferably up to 6 wt %. Preferably, the random copolymer is a copolymer of propylene and ethylene.

The heterophasic copolymer of propylene comprises a dispersed phase, generally constituted by an elastomeric ethylene-propylene copolymer (for example EPR), distributed inside a semi-crystalline polypropylene matrix being a homopolymer of propylene or a random propylene copolymer.

The invention also encompasses polypropylene compositions comprising the polypropylene as defined above.

In an embodiment, the polypropylene composition of the invention may also comprise further additives, such as by way of example, antioxidants, light stabilizers, acid scavengers, lubricants, antistatic additives, nucleating agents and colorants. An overview of such additives may be found in Plastics Additives Handbook, ed. H. Zweifel, 5^{th} edition, 2001, Hanser Publishers. The total content of these additives does generally not exceed 10 parts, preferably not 5 parts, by weight per 100 parts by weight of the final product.

Polymerisation can be carried out in gas phase, slurry conditions or bulk conditions in liquid propylene. In an embodiment, propylene polymerizes in a liquid diluent in the presence of a polymerisation catalyst composition as defined herein, optionally a co-monomer, optionally hydrogen and optionally other additives, thereby producing polymerization slurry comprising polypropylene.

As used herein, the term “polymerization slurry” or “polymer slurry” or “slurry” means substantially a multi-phase composition including at least polymer solids and a liquid phase, the liquid phase being the continuous phase. The solids include catalyst and a polymerized olefin, in the present case bimodal polypropylene. The liquids include an inert diluent, such as isobutane, dissolved monomer such as propylene, co-monomer, molecular weight control agents, such as hydrogen, antistatic agents, antifouling agents, scavengers, and other process additives.

Suitable diluents are well known in the art and include but are not limited to hydrocarbon diluents such as aliphatic, cycloaliphatic and aromatic hydrocarbon solvents, or halogenated versions of such solvents. The preferred solvents are C₁₂ or lower, straight chain or branched chain, saturated hydrocarbons, C₅ to C₉ saturated alicyclic or aromatic hydrocarbons or C₂ to C₆ halogenated hydrocarbons. Non-limiting illustrative examples of solvents are butane, isobutane, pentane, hexane, heptane, cyclopentane, cyclohexane, cycloheptane, methyl cyclopentane, methyl cyclohexane, isooctane, benzene, toluene, xylene, chloroform, chlorobenzenes, tetrachloroethylene, dichloroethane and trichloroethane. In a preferred embodiment of the present invention, said diluent is isobutane. However, it should be clear from the present invention that other diluents may as well be applied according to the present invention.

The person skilled in the art will appreciate that the nature, amounts and concentrations of the above given monomers, co-monomers, polymerisation catalyst, and additional compounds for the polymerization as well as the polymerization time and reaction conditions in the reactor can vary depending on the desired bimodal polypropylene product.

In an embodiment, the process is carried out in a loop reactor, for instance in a single or in a double loop reactor wherein a double loop reactor comprises two loop reactors connected in series. Preferably the process is carried out in a single loop reactor.

For the production of heterophasic propylene copolymers, the polymerization is preferably carried out in one or more reactor in series, employing liquid propylene as reaction medium and then in one or more gas phase reactors in series. It is preferred to produce a heterophasic propylene copolymer sequentially in (a) one or more loop reactors and (b) one or more gas phase reactors. It is most preferred to employ only one gas phase reactor.

The propylene polymers obtained by the process of the present invention may be transformed into articles by a transformation method selected from the group comprising thermoforming, rotomoulding injection moulding, injection blow moulding and injection stretch blow moulding.

Thus the present invention also encompasses articles comprising the polypropylene resin produced according to the present process. Preferred articles are thermoformed articles or molded articles selected from injection molded articles, compression molded articles, rotomoulded articles, injection blow molded articles, and injection stretch blow molded articles, preferably injection molded articles. In an embodiment, the articles are selected from the group consisting of automobile parts, food or non-food packaging, retort packaging, housewares, caps, closures, media packaging, medical devices and pharmacopoeia packages.

The present inventors have found that polypropylene resin produced according to the invention have an improved homogeneity. The process provides thus advantages such as ease of processing.

### Test Methods

The melt flow index (MFI) of a polypropylene or a polypropylene composition is determined according to ISO 1133, condition L, at 230° C. and 2.16 kg.

Molecular weights are determined by Size Exclusion Chromatography (SEC) at high temperature (145° C.). A 10 mg polypropylene sample is dissolved at 160° C. in 10 mL of trichlorobenzene (technical grade) for 1 hour. Analytical conditions for the GPC_IR from Polymer Char are:
Injection volume: +/−400 μL;
Automatic sample preparation and injector temperature: 160° C.;
Column temperature: 145° C.;
Detector temperature: 160° C.;
Column set: 2 Shodex AT-806MS and 1 Styragel HT6E;
Flow rate: 1 mL/min;
Detector: IRS Infrared detector (2800-3000 cm⁻¹);
Calibration: Narrow standards of polystyrene (commercially available);
Calculation for polypropylene: Based on Mark-Houwink relation (log₁₀(M_{PP})=log₁₀(M_{PS})−0,25323); cut off on the low molecular weight end at M_{PP}=1000;
Calculation for polypropylene: Based on Mark-Houwink relation (log₁₀(M_{PE})=0.965909* log₁₀(M_{PS})−0,28264); cut off on the low molecular weight end at M_{PE}=1000.

The molecular weight averages used in establishing molecular weight/property relationships are the number average (Mₙ), weight average (M_{w}) and z average (M_{z}) molecular weight. These averages are defined by the following expressions and are determined form the calculated Mᵢ:

$${M}_{n} = \frac{{\sum }_{i} {N}_{i} {M}_{i}}{{\sum }_{i} {N}_{i}} = \frac{{\sum }_{i} {W}_{i}}{{\sum }_{i} {W}_{i} \text{/} {M}_{i}} = \frac{{\sum }_{i} {h}_{i}}{{\sum }_{i} {h}_{i} \text{/} {M}_{i}}$$

$${M}_{w} = \frac{{\sum }_{i} {N}_{i} {M}_{i}^{2}}{{\sum }_{i} {N}_{i} {M}_{i}} = \frac{{\sum }_{i} {W}_{i} {M}_{i}}{{\sum }_{i} {M}_{i}} = \frac{{\sum }_{i} {h}_{i} {M}_{i}}{{\sum }_{i} {M}_{i}}$$

$${M}_{z} = \frac{{\sum }_{i} {N}_{i} {M}_{i}^{3}}{{\sum }_{i} {N}_{i} {M}_{i}^{2}} = \frac{{\sum }_{i} {W}_{i} {M}_{i}^{2}}{{\sum }_{i} {W}_{i} {M}_{i}} = \frac{{\sum }_{i} {h}_{i} {M}_{i}^{2}}{{\sum }_{i} {h}_{i} {M}_{i}}$$

Here Nᵢ and Wᵢ are the number and weight, respectively, of molecules having molecular weight Mi. The third representation in each case (farthest right) defines how one obtains these averages from SEC chromatograms. hᵢ is the height (from baseline) of the SEC curve at the iₜₕ elution fraction and Mᵢ is the molecular weight of species eluting at this increment.

The molecular weight distribution (MWD or D) is then calculated as Mw/Mn.

The ¹³C-NMR analysis is performed using a 400 MHz or 500 MHz Bruker NMR spectrometer under conditions such that the signal intensity in the spectrum is directly proportional to the total number of contributing carbon atoms in the sample. Such conditions are well known to the skilled person and include for example sufficient relaxation time etc. In practice the intensity of a signal is obtained from its integral, i.e. the corresponding area. The data is acquired using proton decoupling, 2000 to 4000 scans per spectrum with 10 mm room temperature through or 240 scans per spectrum with a 10 mm cryoprobe, a pulse repetition delay of 11 seconds and a spectral width of 25000 Hz (+/−3000 Hz). The sample is prepared by dissolving a sufficient amount of polymer in 1,2,4-trichlorobenzene (TCB, 99%, spectroscopic grade) at 130° C. and occasional agitation to homogenise the sample, followed by the addition of hexadeuterobenzene (C₆D₆, spectroscopic grade) and a minor amount of hexamethyldisiloxane (HMDS, 99.5+%), with HMDS serving as internal standard. To give an example, about 200 mg to 600 mg of polymer are dissolved in 2.0 mL of TCB, followed by addition of 0.5 mL of C₆D₆ and 2 to 3 drops of HMDS.

Following data acquisition the chemical shifts are referenced to the signal of the internal standard HMDS, which is assigned a value of 2.03 ppm.

The syndiotacticity is determined by ¹³C-NMR analysis on the total polymer in accordance with the method described in U.S. Pat. No. 6,184,326B1 which is incorporated by reference in its entirety.

Melting temperatures Tₘ were determined according to ISO 3146 on a DSC Q2000 instrument by TA Instruments. To erase the thermal history the samples are first heated to 200° C. and kept at 200° C. for a period of 3 minutes. The reported melting temperatures Tₘₑₗₜ are then determined with heating and cooling rates of 20° C./min.

Mass spectrometry Samples were analyzed using APPI (Atmospheric Pressure Photolonization): lampe UV (Krypton, 10.6 eV) coupled with IMS-MS (Ion Mobility Spectrometry—Mass Spectrometry) detector using the method known in the art.

The following non-limiting examples illustrate the invention.

### EXAMPLES

The present invention will be further described with reference to the following examples, but it should be construed that the invention is in no way limited to those examples.

### Example 1: Synthesis of the Proligands

The fluorenyl-cyclopentadienyl type proligands (Cp/Flu proligands) of the catalysts have been synthetized by nucleophilic additions of fluorenyl anions to fulvenes (i.e. the “fulvene method”). By comparison to the patent literature, the procedure used the sodium methanolate was replaced by pyrolidine as catalyst of the reaction. The synthesis of para-substituted dilfulvenes (1a-b) was obtained according to reaction scheme 1:

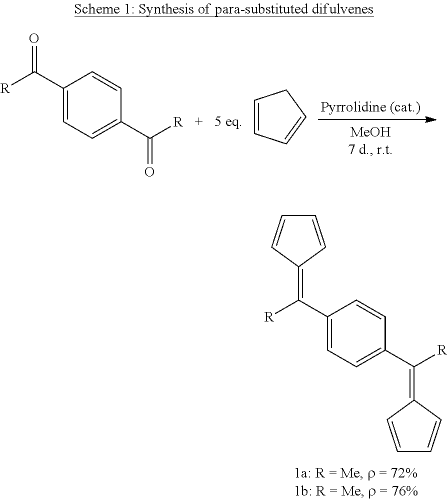

1,4-Bis(1-(cyclopenta-2,4-dien-1-ylidene)ethyl)benzene (1a): In a 250 mL round bottom flask equipped with a magnetic stirring bar and a nitrogen inlet freshly cracked cyclopentadiene (12.36 mL, 148 mmol) and 1,4-diacetylbenzene (4.82 g, 30 mmol) were dissolved in methanol (200 mL). To this solution pyrrolidine (7.5 mL, 89 mmol) was added at 0° C. The reaction mixture was stirred at room temperature for 7 days. After neutralization with glacial acetic acid (7.5 mL) and separation of the organic phase, volatiles were evaporated under vacuum to give a yellow powder (5.51 g, 21.3 mmol, 72%).

1,4-Bis(cyclopenta-2,4-dien-1-ylidenemethyl)benzene (1b): Using a protocol similar to that described above for 1,4-bis(1-(cyclopenta-2,4-dien-1-ylidene)ethyl)benzene, 1,4-bis(cyclopenta-2,4-dien-1-ylidenemethyl)benzene was prepared from cyclopentadiene (30.7 mL, 373 mmol), 1,3-terephthalaldehyde (10.0 g, 74.5 mmol) and pyrrolidine (9.3 mL, 112 mmol) and isolated as an orange powder (13.03 g, 56.7 mmol, 76%).

The synthesis of meta-substituted difulvenes (1c-d) was obtained according to reaction scheme 2:

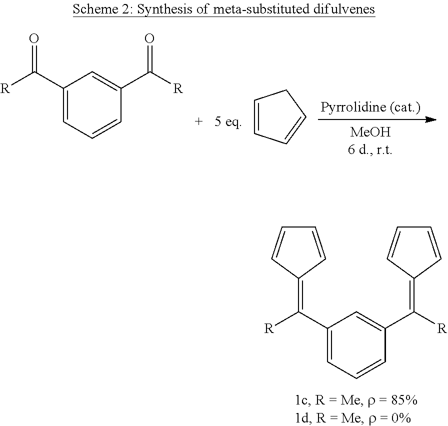

1,3-Bis(1-(cyclopenta-2,4-dien-1-ylidene)ethyl)benzene (1c): Using a protocol similar to that described above for 1,4-bis(1-(cyclopenta-2,4-dien-1-ylidene)ethyl)benzene, 1,3-bis(1-(cyclopenta-2,4-dien-1-ylidene)ethyl)benzene was prepared from cyclopentadiene (30.0 mL, 363 mmol), 1,3-diacetylbenzene (11.0 g, 68 mmol) and pyrrolidine (17.0 mL, 204 mmol) and isolated as an orange powder (14.9 g, 51 mmol, 85%).

Compounds 1a-c were obtained in very good yields but the corresponding meta-substituted difulvene 1d could not be obtained using this procedure, or Thiele's procedure (using methalonate instead of pyrrolidine) or even by using sodium cyclopentadienyl as reactant

Then, to prepare the target bis{fluorenyl-cyclopentadienyl} type proligands (2a-c), these difulvenes were subsequently reacted with two equivalents of [3,6^{t}Bu₂Flu]⁻ Li⁺ as described in reaction scheme 3 starting from the para-substituted dilfulvenes and in reaction scheme 4 starting from the meta-substituted dilfulvenes:

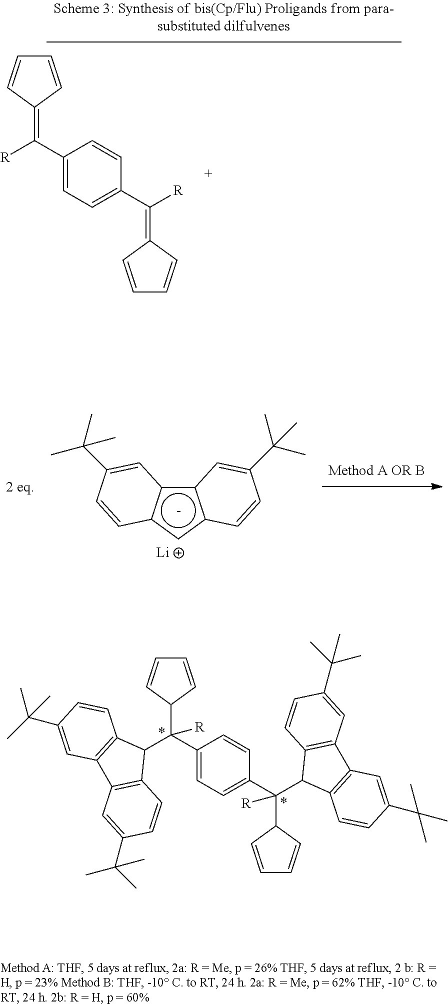

Two methods were investigated to form these proligands and the yields could be improved by carrying out the addition of fluorenyllithium solution to the difulvene solution at −10° C. (Method B).

### 1,4-Bis(1-(cyclopentadienyl)-1-(3,6-di-tert-butyl-fluorenyl)ethyl)benzene (2a)

Method A: In a Schlenk flask, to a solution of 3,6-di-tert-butyl-fluorene (2.17 g, 7.8 mmol) in THF (100 mL) was added n-butyllithium (3.13 mL of a 2.5 M solution in hexane, 7.8 mmol). This solution was added dropwise to a solution of 1,3-bis(1-(cyclopenta-2,4-dien-1-ylidene)ethyl)benzene (1.00 g, 3.9 mmol) in THF (100 mL) at room temperature over 10 minutes. The reaction mixture was stirred for 5 days under reflux. The mixture was hydrolyzed with 10% aqueous hydrochloric acid (20 mL), the organic phase was dried over sodium sulfate, and the solvent was evaporated in vacuo. The resulting solid was washed with pentane (200 mL) and dried to obtain a white powder (731 mg, 0.91 mmol, 26%).

Method B: The procedure is similar to the previous Method A, except that addition of the fluorenyllithium solution was carried out at −10° C. over 10 min. After completion of the addition, the reaction mixture was stirred for 24 h at room temperature. Identical work-up afforded the title compound as a white powder (1.96 g, 2.4 mmol, 62%).

### 1,4-Bis(1-(cyclopentadienyl)-1-(3,6-di-tert-butyl-fluorenyl)methyl)benzene (2b)

Method A: Using a protocol similar to that described above for 1,4-bis(1-(cyclopentadienyl)-1-(3,6-di-tert-butyl-fluorenyl)ethyl)benzene, the title compound was prepared from 3,6-di-tert-butyl-fluorene (4.83 g, 17.4 mmol), n-butyllithium (7.0 mL of a 2.5 M solution in hexane, 17.4 mmol), 1,4-bis(cyclopenta-2,4-dien-1-ylidenemethyl)benzene (2.00 g, 8.7 mmol) and isolated as a white powder (1.66 g, 2.1 mmol, 23%).

Method B: Using a protocol similar to that described above for 1,4-bis(1-(cyclopentadienyl)-1-(3,6-di-tert-butyl-fluorenyl)ethyl)benzene, the title compound was prepared from 3,6-di-tert-butyl-fluorene (4.83 g, 17.4 mmol), n-butyllithium (7.0 mL of a 2.5 M solution in hexane, 17.4 mmol), 1,4-bis(cyclopenta-2,4-dien-1-ylidenemethyl)benzene (2.00 g, 8.7 mmol) and isolated as a white powder (60%)

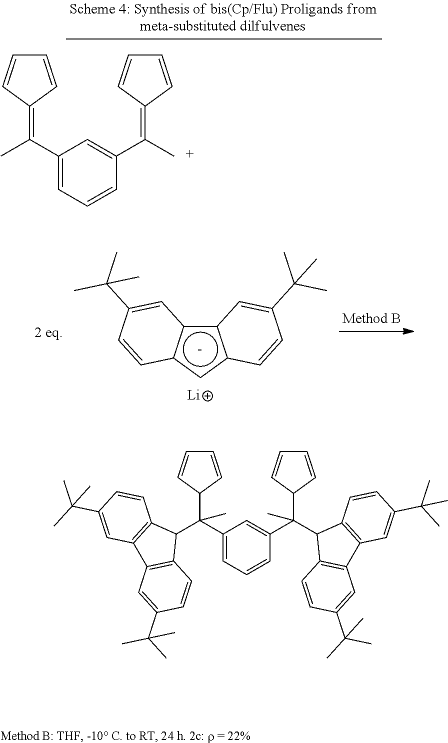

### 1,3-Bis(1-(cyclopentadienyl)-1-(3,6-di-tert-butyl-fluorenyl)ethyl)benzene (2c)

Method B: In a Schlenk flask, to a solution of 3,6-di-tert-butyl-fluorene (2.17 g, 7.8 mmol) in THF (50 mL) was added n-butyllithium (3.13 mL of a 2.5 M solution in hexane, 7.8 mmol). This solution was added dropwise to a solution of 1,3-bis(1-(cyclopenta-2,4-dien-1-ylidene)ethyl)benzene (1.00 g, 3.9 mmol) at −10° C. over 10 min. After completion of the addition, the reaction mixture was stirred for 24 h at room temperature. The mixture was hydrolyzed with 10% aqueous hydrochloric acid (20 mL), the organic phase was separated and dried over sodium sulfate, and the solvent was evaporated in vacuo. The resulting solid was washed with pentane (100 mL) and dried to leave a white powder (469 mg, 0.58 mmol, 22%).

### Example 2: Synthesis of Homo Bis(Metallocene)s

Bis(metallocene) zirconium complexes were obtained using a standard salt metathesis reaction between 2 equivalents of the corresponding tetrachloride precursors (ZrCl₄) and ligand tetra anions, prepared in situ via addition of four equivalents of n-butyllithium in Et₂O, in accordance with reaction schemes 5 and 6.

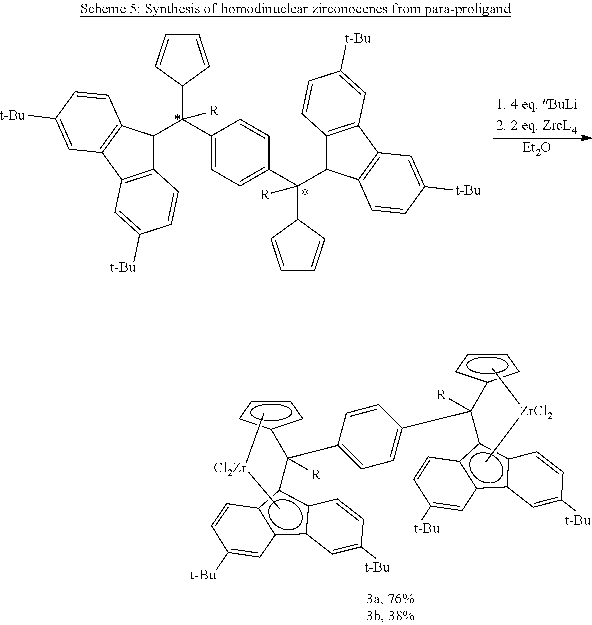

### 1,4-Benzenebis{(cyclopenta-2,4-dien-1-yl(3,6-di-tert-butyl-fluoren-9-yl)ethyl)zirconiumdichloride} (3a)

To a solution of 1,4-bis(cyclopenta-2,4-dien-1-yl(3,6-di-tert-butyl-fluoren-9-yl)ethyl)benzene (0.50 g 0.61 mmol) in diethyl ether (50 mL) was added under stirring n-butyllithium (0.98 mL of a 2.0 M solution in hexane, 2.45 mmol, 4 equiv.). The solution was kept overnight at room temperature. Then ZrCl₄ (0.286 g, 1.23 mmol, 2 equiv.) was added with a bent finger. The resulting red mixture was stirred at room temperature overnight. Then, the mixture was evaporated under vacuum, CH₂Cl₂ (20 mL) was added, the resulting solution was filtered and the solvent was evaporated in vacuo to give a red powder (0.528 g, 0.46 mmol, 76%).

### 1,4-Benzenebis{(cyclopenta-2,4-dien-1-yl(3,6-di-tert-butyl-fluoren-9-yl)methyl)zirconiumdichloride} (3b)

This compound was prepared as described above for 3a, starting from 1,4-bis(cyclopenta-2,4-dien-1-yl(3,6-di-tert-butyl-fluoren-9-yl)methyl)benzene (0.66 g, 0.84 mmol), n-butyllithium (1.37 mL of a 2.0 M solution in hexane, 3.37 mmol, 4 equiv.) and ZrCl₄ (0.392 g, 1.68 mmol, 2 equiv.). The compound was isolated as a red powder (0.350 g, 0.32 mmol, 38%).

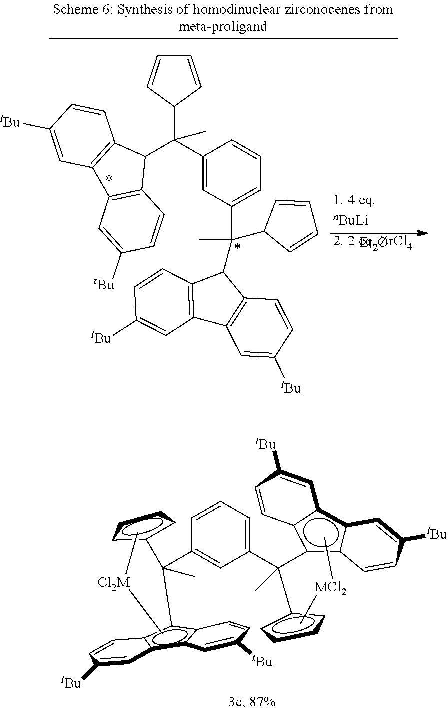

### 1,3-Benzenebis{(cyclopenta-2,4-dien-1-yl(3,6-di-tert-butyl-fluoren-9-yl)ethyl)zirconiumdichloride} (3c)

This compound was prepared as described above for 3a starting from 3,6-di-tert-butyl-9-(1-(cyclopenta-2,4-dien-1-yl)-1-phenylethyl)-9H-fluorene (0.52 g, 0.64 mmol), n-butyllithium (1.0 mL of a 2.5 M solution in hexane, 2.55 mmol, 2 equiv.) and ZrCl₄ (0.30 g, 1.27 mmol). The product was isolated as a red powder (0.63 g, 0.56 mmol, 87%).

Dinuclear hafnium complexes were obtained using the same standard salt metathesis reaction between 2 equivalents of the corresponding tetrachloride precursors (HfCl₄) and I tetra anion ligand, prepared in situ via addition of four equivalents of n-butyllithium in Et₂O, in accordance with reaction scheme 7.

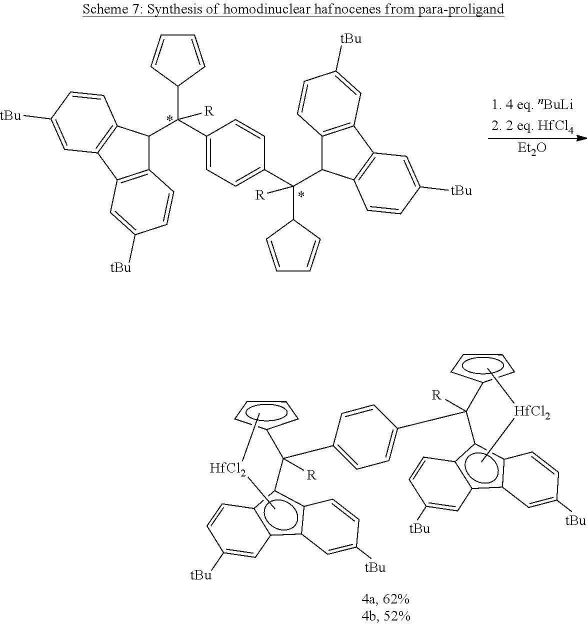

### 1,4-benzenebis{(cyclopenta-2,4-dien-1-yl(3,6-di-tert-butyl-fluoren-9-yl)ethyl)hafniumdichloride} (4a)

This compound was prepared as described above for 3a starting from 1,4-bis(cyclopenta-2,4-dien-1-yl(3,6-di-tert-butyl-fluoren-9-yl)ethyl)benzene (0.50 g, 0.61 mmol), n-butyllithium (0.98 mL of a 2.5 M solution in hexane, 2.45 mmol, 4 equiv.) and HfCl₄ (2 equiv.). The compound was recovered as a yellow powder (0.52 g, 0.38 mmol, 62%).

### 1,4-benzenebis{(cyclopenta-2,4-dien-1-yl(3,6-di-tert-butyl-fluoren-9-yl)methyl)hafniumdichloride} (4b)

This compound was prepared as described above for 3a starting from 1,4-bis(cyclopenta-2,4-dien-1-yl(3,6-di-tert-butyl-fluoren-9-yl)methyl)benzene (0.50 g, 0.61 mmol), n-butyllithium (0.98 mL of a 2.5 M solution in hexane, 2.45 mmol, 4 equiv.) and HfCl₄ (2 equiv.). The compound was recovered as a yellow powder (0.43 g, 52%).

### Example 3: Synthesis of Hetero Bis(Metallocene)s

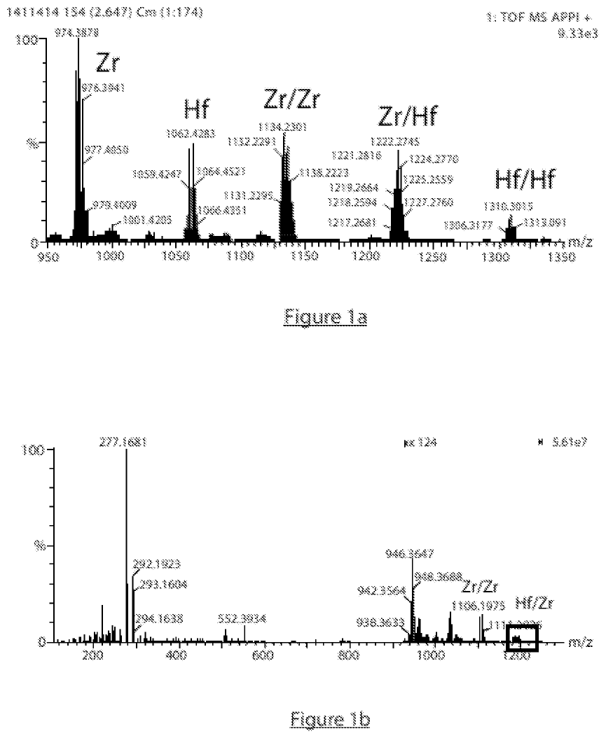

Hetero bis(metallocene) complexes were obtained using a salt metathesis reaction between one equivalent of each tetrachloride precursors (ZrCl₄ and HfCl₄) and ligand tetra anions, prepared in situ via addition of four equivalents of n-butyllithium in Et₂O, in accordance with reaction Scheme 8. The results is a mixture of homo and hetero bis(metallocene) complexes. The presence of hetero bis(metallocene) complexes has been evidenced by mass spectrometry. FIG. 1 shows the mass spectrum of 5a.

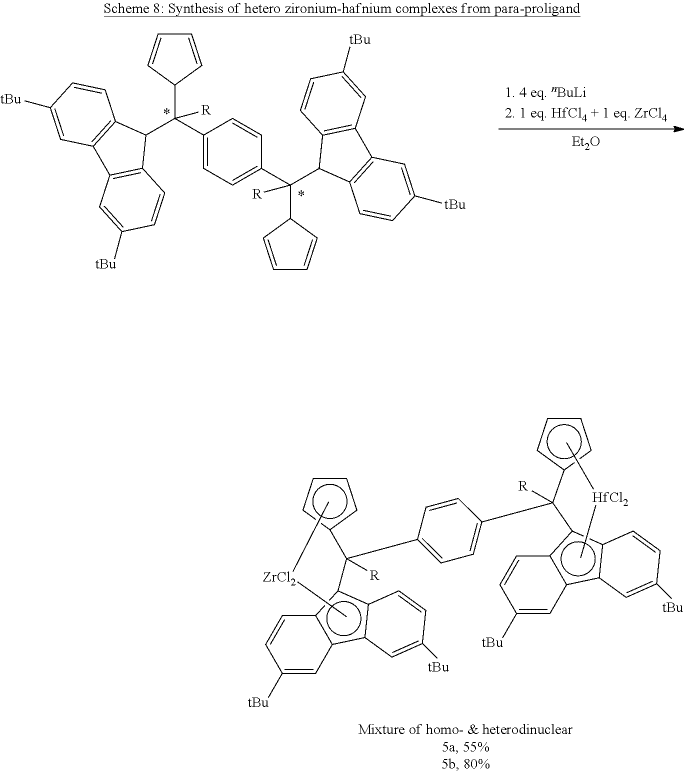

### 1,4-benzenebis{(cyclopenta-2,4-dien-1-yl(3,6-di-tert-butyl-fluoren-9-yl)ethyl)zirconiumhafniumdichloride} (5a)

This compound was prepared as described above for 3a starting from 1,4-bis(cyclopenta-2,4-dien-1-yl(3,6-di-tert-butyl-fluoren-9-yl)ethyl)benzene (1 g, 1 equiv.), n-butyllithium (2.5 M solution in hexane, 4 equiv.) and ZrCl₄ (1 equiv.) and HfCl₄ (1 equiv.). The compound was recovered as a yellow powder (0.8 g, 55%).

### 1,4-benzenebis{(cyclopenta-2,4-dien-1-yl(3,6-di-tert-butyl-fluoren-9-yl)methyl)zirconiumhafniumdichloride} (5b)

This compound was prepared as described above for 3a starting from 1,4-bis(cyclopenta-2,4-dien-1-yl(3,6-di-tert-butyl-fluoren-9-yl)methyl)benzene (1 g, 1 equiv.), n-butyllithium (2.5 M solution in hexane, 4 equiv.) and ZrCl₄ (1 equiv.) and HfCl₄ (1 equiv.). The compound was recovered as a yellow powder (1.2 g, 80%).

### Example 4: Synthesis of Mononuclear Metallocene Analogues

To investigate the catalytic properties of the dinuclear complexes according to the invention in olefin polymerisation, their mononuclear analogues were also synthetized according to reaction scheme 9. Complexes 3a′ and 3b′ were isolated in very good yield.

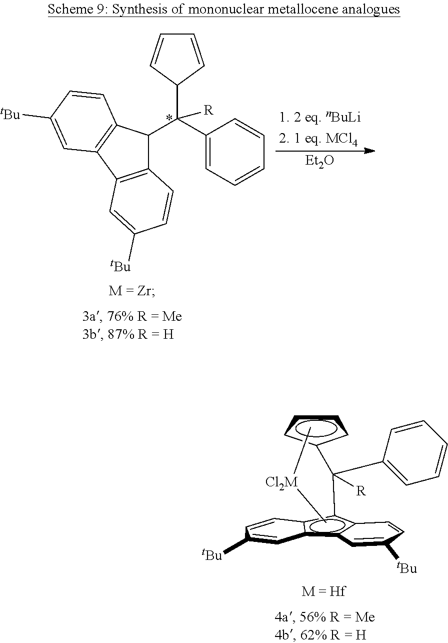

{Ph(Me)C-(3,6^{t}Bu₂Flu)(Cp)}ZrCl₂ (3a′): This compound was prepared as described above for 3a starting from 3,6-di-tert-butyl-9-(1-(cyclopenta-2,4-dien-1-yl)-1-phenylethyl)-9H-fluorene (0.40 g 0.89 mmol), n-butyllithium (0.72 mL of a 2.5 M solution in hexane, 1.79 mmol, 2 equiv.) and ZrCl₄ (0.209 g, 0.89 mmol, 1 equiv.). The compound was isolated as a red powder (0.410 g, 0.67 mmol, 76%).

{Ph(H)C-(3,6^{t}Bu₂Flu)(Cp)}ZrCl₂ (3b′): This compound was prepared as described above for 3a starting from 3,6-di-tert-butyl-9-(1-(cyclopenta-2,4-dien-1-yl)-1-phenylethyl)-9H-fluorene (0.43 g, 0.99 mmol), n-butyllithium (0.81 mL of a 2.5 M solution in hexane, 1.99 mmol, 2 equiv.) and ZrCl₄ (0.23 g, 0.99 mmol). The product was isolated as a red powder (0.54 g, 0.86 mmol, 87%).

{Ph(Me)C-(3,6^{t}Bu₂Flu)(Cp)}HfCl₂ (4a′): This compound was prepared as described above for 3a starting from 3,6-di-tert-butyl-9-(1-(cyclopenta-2,4-dien-1-yl)-1-phenylethyl)-9H-fluorene (0.40 g 0.89 mmol), n-butyllithium (0.72 mL of a 2.5 M solution in hexane, 1.79 mmol, 2 equiv.) and HfCl₄ (1 equiv.). The compound was isolated as a yellow powder (yield: 56%).

{Ph(H)C-(3,6^{t}Bu₂Flu)(CP)}HfCl₂ (4b′): This compound was prepared as described above for 3a starting from 3,6-di-tert-butyl-9-(1-(cyclopenta-2,4-dien-1-yl)-1-phenylethyl)-9H-fluorene (0.43 g, 0.99 mmol), n-butyllithium (0.81 mL of a 2.5 M solution in hexane, 1.99 mmol, 2 equiv.) and HfCl₄ (1 equiv.). The product was isolated as a yellow powder (yield: 62%).

### Example 5: Polypropylene Polymerization

Polymerization reactions were performed in a 8 liter autoclave with an agitator, a temperature controller and inlets for feeding of propylene and hydrogen.

The reactor was dried at 130° C. with nitrogen during one hour and then cooled to 60° C. Reactor was loaded with 4.5 liter of propylene and 0.36 g of hydrogen. Catalyst (0.1 g) was diluted with 1 mL of a 10 wt % triethylaluminum solution in n-hexane. Polymerization started upon catalyst injection and was stopped after 60 minutes by reactor depressurization. Reactor was flushed with nitrogen prior opening and the polymer was recovered as a free flowing powder.

The results on the obtained polyolefin are displayed in Table 1.

TABLE 1
Propylene polymerisation

| | supported | activity | GPC | | | | | NMR |
|---|---|---|---|---|---|---|---|---|
| Ref | metallocene | g/g/h | Mn | Mw | Mz | Mw/Mn | Mz/Mw | rrrr |
| PP01 | 3b′ | 1950 | 40331 | 93995 | 166588 | 2.3 | 1.8 | 81.9 |
| PP02 | 3a′ | 390 | 48892 | 126973 | 233516 | 2.6 | 1.8 | 81.8 |
| PP03 | 3a | 270 | 25342 | 71613 | 155601 | 2.8 | 2.2 | 66.7 |
| PP04 | 5a | 350 | 27386 | 113561 | 512086 | 4.1 | 4.5 | 66.7 |
| PP05 | 5b | 410 | 29305 | 133378 | 661228 | 4.6 | 5 | 69.6 |
| PP06 | 3b | 1020 | 24816 | 73940 | 165231 | 3 | 2.2 | 70.1 |
| PP07 | 4b | No activity | — | — | — | — | — | — |
| PP08 | 4a | No activity | — | — | — | — | — | — |
| PP09 | 4b′ | No activity | — | — | — | — | — | — |
| PP10 | 4a′ | No activity | — | — | — | — | — | — |

PP01, PP02, PP09 and PP10 are comparative examples as the catalyst used was a mononuclear metallocene.

PP07 and PP08 are also comparative examples as the dinuclar metallocene used did not contained Zirconium.

The polypropylenes produced with Zirconium binuclear complex have a molecular weight distribution broader than the one obtained for polypropylene polymerised with Zirconium mononuclear complex. The broadening is more important for hetero bis(metallocene) complex Zr—Hf and reveals a bimodal structure of the polymer. It is believed that the hafnium component of the bis(metallocene) complex is activated by the presence of the zirconium component. This is surprising as the hafnium mono- or bis(metallocene) complex were found to be inactive.

1.-15. (canceled)

16. A process for the production of propylene polymers, said process comprising the step of polymerizing propylene monomer and one or more olefin co-monomer in one or more polymerization reactors in presence of a catalyst composition characterized in that the catalyst composition comprises a bis(metallocene) compound (A) having one of the following formulas: 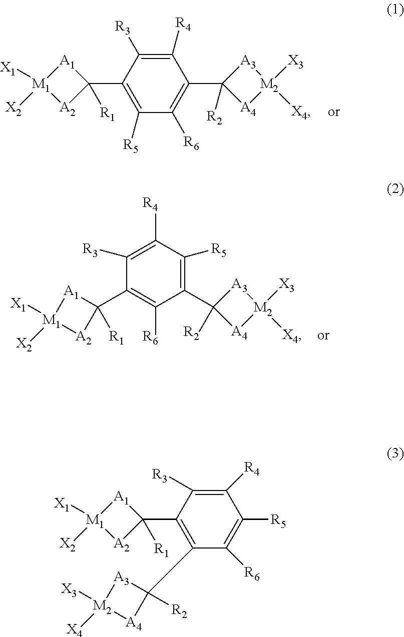
wherein
A1 and A3 are the same or different substituted or unsubstituted cyclopentadienyl rings, or substituted or unsubstituted fluorenyl rings, or substituted or unsubstituted indenyl rings, wherein if substituted, the substitutions may be independent and/or linked to form multicyclic structures;
A2 and A4 are the same or different and selected from substituted or unsubstituted cyclopentadienyl rings or substituted or unsubstituted fluorenyl rings, or substituted or unsubstituted indenyl rings;
X1, X2, X3 and X4 are independently hydrogen, halogen, hydride group, hydrocarbyl group, substituted hydrocarbyl group, alkoxyde group, substituted alkoxyde group, aryloxide group, substituted aryloxide group, halocarbyl group, substituted halocarbyl group, silylcarbyl group, substituted silylcarbyl group, germylcarbyl group, substituted germylcarbyl group, or both X1 and X2 and/or both X3 and X4 are joined and bound to the metal atom to form a metallacycle ring containing from 3 to 20 carbon atoms;
M1 is Zirconium;
M2 is selected from Zirconium, Hafnium and Titanium;
R1 and R2 are independently hydrogen or a substituted or unsubstituted aliphatic, aromatic, or cyclic group;
R3, R4, R5 and R6 are independently hydrogen or a substituted or unsubstituted aliphatic, aromatic, or cyclic group.

17. The process according to claim 16 characterized in that, in the bis(metallocene) compound (A), both M1 and M2 are zirconium or M1 and M2 are different and M2 is Hafnium.

18. The process according to claim 16 characterized in that in the bis(metallocene) compound (A), A1 and A3 are the same and A2 and A4 are the same so that the bis(metallocene) compound (A) shows a symmetry.

19. The process according to claim 16 characterized in that in the bis(metallocene) compound (A) one or more of the following is true:
R1 and R2 are independently hydrogen or a methyl group, and/or
R3, R4, R5 and R6 are hydrogen, and/or,
at least one of A1, A2, A3 or A4 is a fluorenyl ring.

20. The process according to claim 16 characterized in that the bis(metallocene) compound (A) is:

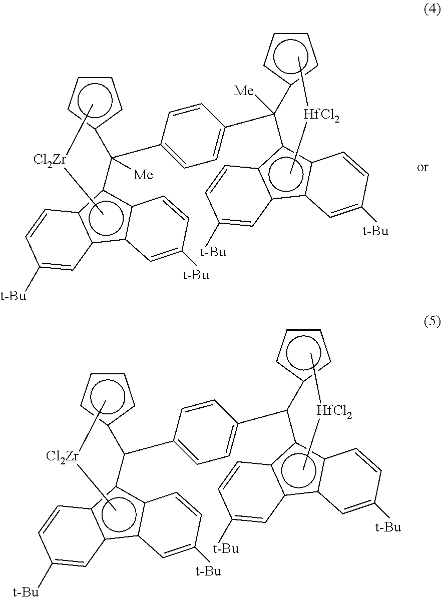

21. The process according to claim 16 characterized in that the catalyst composition further comprises a co-catalyst (B).

22. The process of claim 21 characterized in that the co-catalyst (B) is an alumoxane selected from methylalumoxane, modified methyl alumoxane, ethylalumoxane, isobutylalumoxane, or any combination thereof.

23. The process of claim 21 characterized in that the co-catalyst is an ionic activator selected from dimethylanilinium tetrakis(perfluorophenyl)borate, triphenylcarbonium tetrakis (perfluorophenyl) borate, dimethylanilinium tetrakis(perfluorophenyl)aluminate, or any combination thereof.

24. The process of claim 16 characterized in that the co-catalyst (B) is an ionic activator used in combination with a co-activator being a trialkylaluminium selected from Tri-Ethyl Aluminum (TEAL), Tri-lso-Butyl Aluminum (TIBAL), Tri-Methyl Aluminum (TMA), and Methyl-Methyl-Ethyl Aluminum (MMEAL).

25. The process according to claim 16 characterized in that the bis(metallocene) compound (A) is or comprises a mixture of a homo bis(metallocene) wherein both M1 and M2 are Zirconium and of a hetero bis(metallocene) wherein M1 and M2 are different and further wherein M2 is Hafnium.

26. The process according to claim 16 characterized in that the process is performed in a single reactor.

27. The process according to claim 16 characterized in that the polymerization is carried out in bulk conditions.

28. The process according to claim 16 characterized in that the polypropylene polymer is a bimodal propylene polymer.

29. The process according to claim 16 characterized in the polypropylene polymer has a content of rrrr pentads ranging from 65 to 90 mol % as determined by ¹³C-NMR analysis.
